(19) United States
(12) Patent Application Publication
(10) Pub. No.: US 2014/0109889 A1
(43) Pub. Date: Apr. 24, 2014

(54) Oxygen Activated Heater With Thermal Regulator

(71) Applicant: Rechargeable Battery Corporation, College Station, TX (US)

(72) Inventors: Christopher Pedicini, Nashville, TN (US); Wesley Pedicini, Nashville, TN (US); Adam Laubach, Kingwood, TX (US); Charles Sesock, College Station, TX (US)

(21) Appl. No.: 14/058,496

(22) Filed: Oct. 21, 2013

Related U.S. Application Data
(60) Provisional application No. 61/716,279, filed on Oct. 19, 2012.

(51) Int. Cl. F24J 1/00; C09K 5/18

(52) U.S. Cl. CPC F24J 1/00; C09K 5/18
USPC 126/263.02

(57) ABSTRACT

An oxygen based heater including a substrate that produces heat in the presence of oxygen at a maximum temperature a thermal regulator material, preferably having a melting point lower than the maximum temperature, wherein a maximum temperature of the heater is approximately the same as the maximum temperature of the thermal regulation layer.

### CROSS REFERENCE TO RELATED APPLICATIONS

This application claims priority to U.S. Provisional Patent Application No. 61/716,279 filed on Oct. 19, 2012, the entirety of which is incorporated herein.

### FIELD OF THE INVENTION

The invention relates to a heater that uses oxygen (generally atmospheric oxygen) as a source of a chemical reactant for an exothermic reaction, and more specifically to a heater that includes a thermal regulator material.

### BACKGROUND OF THE INVENTION

Portable flameless heaters are currently used in a variety of applications, such as heating comestible items.

Some heaters utilize the reaction of magnesium and water to produce heat. While such a heater does produce sufficient heat, hydrogen gas is product of the exothermic reaction—generating safety, transportation, storage, and disposal concerns. Also, the exothermic reaction requires water—which can be tiresome to constantly carry around.

Other heaters use the heat from the reaction of “quicklime” (calcium oxide) and water. While this reaction does not generate hydrogen as a byproduct, it still is based upon using water as a reactant. Again, this requires a user to constantly have a sufficient amount of water. Furthermore, the specific energy of the system is low (approximately 1.2 kJ per gram of CaO), making it a suitable but ineffective alternative.

In addition to the water-based heaters described above, it is known to utilize oxygen-based heaters. Oxygen-based heaters, such as those described in U.S. Pat. Nos. 5,984,995, 5,918,590 and 4,205,957, have certain benefits over water-based heaters.

First, oxygen-based heaters do not require the addition of water to generate heat. Second, because oxygen-based heaters generate heat only in the presence of oxygen, the exothermic reaction can be stopped by simply preventing oxygen access. In addition, some such heaters allow for the exothermic reaction to be restarted at a later time by re-introducing oxygen. Furthermore, since oxygen is abundant in the atmosphere, these heaters do not require mixing of components or additional reactants (as oxygen from the atmosphere is the only missing reactant).

The assignee of the present invention has provided oxygen-base heaters and various packages for same. See, e.g., U.S. Pat. No. 7,722,782, issued on May 25, 2010; U.S. application Ser. No. 12/376,927, filed on Feb. 9, 2009; U.S. application Ser. No. 12/874,338, filed on Sep. 2, 2010; U.S. application Ser. No. 61/583,410, filed on Jan. 5, 2012; U.S. Appl. Ser. No. 61/583,418, filed on Jan. 5, 2012; and, U.S. Appl. Ser. No. 61/714,526, filed on Oct. 16, 2012; all of which are incorporated herein by reference.

These disclosed heaters and packages are successful at providing an oxygen based heater and/or package for same.

The present invention is directed to improving such a heater to provide further benefits associated with same.

### SUMMARY OF THE INVENTION

In one aspect of the present invention, the present invention is directed towards an oxygen based heater that includes a thermal regulator material. It is contemplated that the thermal regulator material comprises a wax, polymer, or other similar composition.

In certain embodiments of the present invention, the thermal regulator material can be a sheet. By “sheet” it is meant that some outer portions of the heater substrate include a thermal regulator material and it is not meant that the thermal regulation layer must be a continuous expanse on a surface of the heater substrate. Further, in such embodiments, when the heater substrate is made, the thermal regulation material is not used to make same. Rather, it is contemplated that the thermal regulation material can be added after the heater substrate has already been made.

In some embodiments, the thermal regular material can be applied to a secondary substrate, like a pad or other structure within heater.

It is further contemplated that thermal regulator material be added to heater substrate during the manufacturing process so as to be integral with heater substrate.

The thermal regulator material has multiple functions and provides multiple benefits as a result of same.

First, the use of a thermal regulator material will allow the oxygen based heater to have a controlled and selected maximum temperature. More specifically, like the water in water based heaters, the thermal regulator material will absorb heat until it reaches its melting point. In theory, until the entirety of the thermal regulator material is melted, the heater will stay at the temperature of the melting point of the material in the thermal regulator material. (It is not necessarily desired to melt away any portions of the thermal regulator material).

Accordingly, by using a thermal regulator material, one can effectively control the maximum temperature of the heater. This allows for specific heaters to be engineered with varying specific maximum temperatures based upon the different melting points of the various materials in the thermal regulator material. Thus, a heater with a certain use, heating food for example, could have a different maximum temperature when compared with a heater having a different use, for example, heating a user's skin for warmth. In accordance with some of the embodiments of the present invention the same heater substrate could be used to make both of these heaters—with the temperature being controlled by a thermal regulator material.

A further benefit of a thermal regulator relates to the control of the overall electrochemical reaction in the heater. It has been determined that the best heating results are obtained when there is sufficient electrolyte in the heater to mediate the reaction of the oxygen-based heater. If the heater temperature rises above the boiling point of the electrolyte solution then water will be boiled away, causing the heating reaction to diminish or cease. Accordingly, selection of the amount and type of a thermal regulator designed to maintain the heater temperature below the boiling point of the electrolyte solution may allow for a heater that is more efficient and delivers more total energy to the desired product.

Similarly, in applications that involve human interaction, it is desirable and preferred that the thermal regulator material be selected based upon its ability to obtain and maintain a maximum temperature of approximately 60° C. It is believed that this temperature is generally recognized as a temperature that is safe for human interaction and one that will not destroy the object(s) being heated.

In addition to the temperature control, the thermal regulator material will also act as a heat sink, absorbing heat and melting at a molecular level. After the heat generating reaction has been stopped, the material will (at the molecular level) begin solidifying and slowly releasing heat as a result of same. This may allow for a heater that emits heat longer without actually consuming reactants.

These and other benefits should be apparent to those of ordinary skill in the art in view of the present disclosure,

It is to be understood that the aspects and objects of the present invention described above may be combinable and that other advantages and aspects of the present invention will become apparent to those having ordinary skill in the art upon reading the following description of the drawing and the detailed description thereof.

### BRIEF DESCRIPTION OF THE DRAWINGS

The present invention will become more fully apparent from the following description and appended claims, taken in conjunction with the accompanying drawings. Understanding that the accompanying drawings depict only typical embodiments, and are, therefore, not to be considered to be limiting of the scope of the present disclosure, the embodiments will be described and explained with specificity and detail in reference to the accompanying drawings as provided below.

FIG. 1 is a front view of a heater according to the present invention.

FIG. 2 is a side exploded view of a heater according to an embodiment of the present invention.

FIG. 3 is graph showing results of a comparison of an embodiment of the present invention and a control.

FIG. 4 is graph showing results of a comparison of embodiments of the present invention and various controls.

### DETAILED DESCRIPTION OF THE DRAWINGS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

Reference throughout this description to features, advantages, objects or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, any discussion of the features and advantages, and similar language, throughout this specification may, but does not necessarily, refer to the same embodiment.

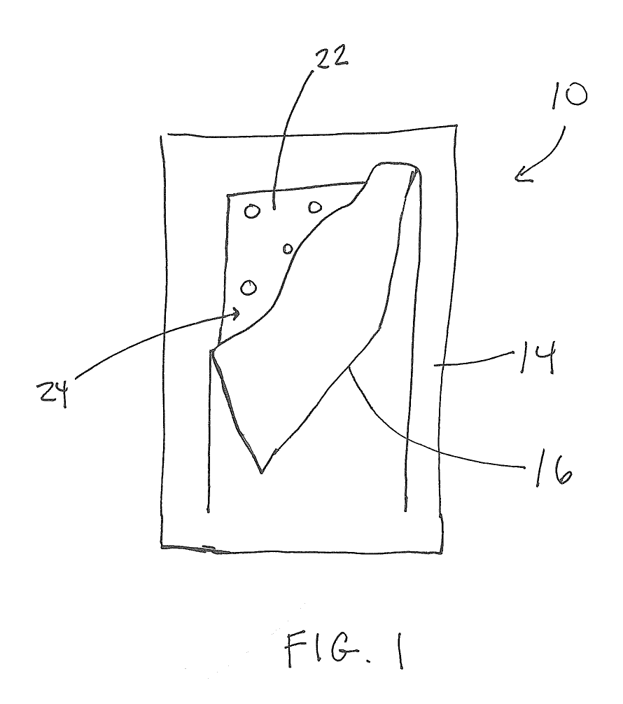

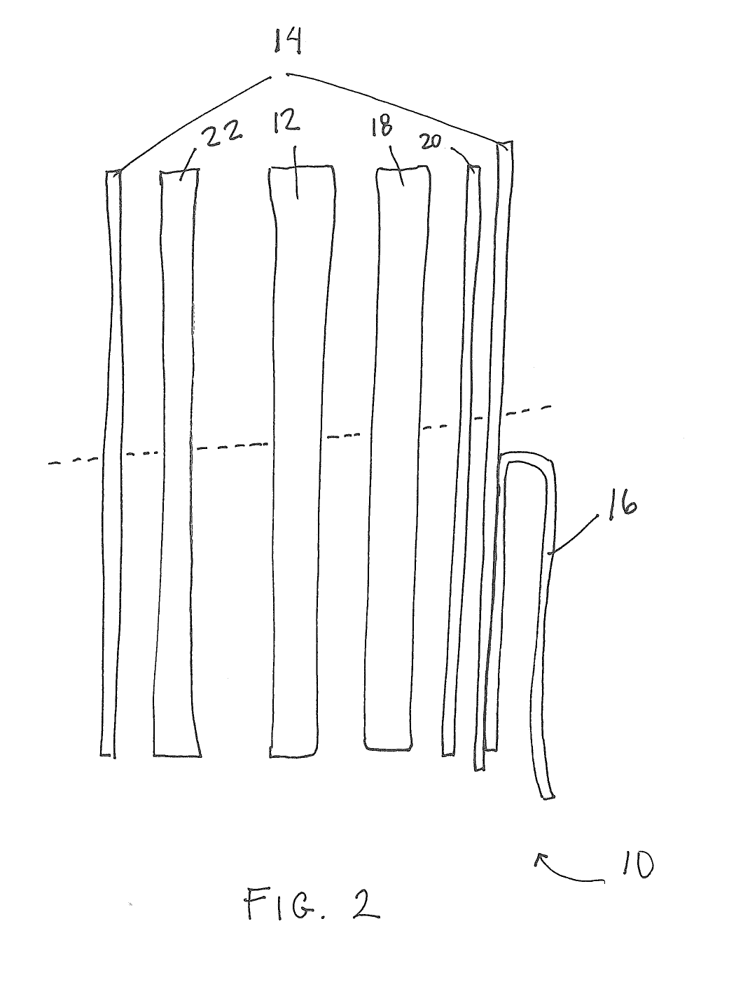

As shown in FIGS. 1 and 2, heater 10 according to various embodiments of the present invention includes a substrate 12 disposed in package 14.

The heater substrate 12 typically includes a reducing agent, such as aluminum or zinc, and a binding agent, such as polytetrafluoroethylene or a polyolefin. The reducing agent reacts with oxygen (preferably atmospheric or mostly atmospheric oxygen) in an exothermic reaction.

Package 14 secludes heater substrate 12 from the oxygen until desired. In a preferred embodiment, package 14 includes seal 16 that can be removed (at least partially) from package 14 to allow oxygen to reach heater substrate 12 through opening 24 and react. One of ordinary skill in the art will appreciate that other structures may be used in place of seal 16. Additionally, it is preferred that seal 16 be configured to re-attach to package so that heater 10 can be re-used (provided the chemicals in heater substrate 12 have not been fully reacted).

In order to sustain the exothermic reaction, heater 10 also includes an electrolyte—typically an electrolyte solution. The electrolyte solution may be impregnated on heater substrate 12. Alternatively, it is contemplated that heater include pad 18 and that during production, electrolyte solution is impregnated on pad 18 and subsequently transferred to heater substrate 12. Thus the term “electrolyte pad” refers to pad 18 that was originally impregnated with an electrolyte solution and which may include some amounts of same after the solution has flowed onto heater substrate 12.

Finally, heater 10 may also include oxygen diffuser 20 to regulate oxygen access into heater 10 and to heater substrate 12.

According to various embodiments of the present invention, heater 10 also includes thermal regulator material. As previously mentioned, contemplated materials for the thermal regulator material include wax, such as paraffin wax, polymers, mixtures thereof, organic and synthetic hydrocarbon chains having appropriate melting points, and/or low melting point metals or alloys, such as bismuth or solders.

In some embodiments, and as shown in FIG. 2, thermal regulator material may comprise sheet 22 adjacent substrate 12 and within package 14. In order to maximize heat transfer, sheet 22 and substrate 12 should be in thermal contact, preferably directly.

Alternatively or additionally, thermal regulator material can be integral in heater substrate 12.

Also alternatively or additionally, thermal regulator material may be present on additional structures in package 14, such as pad 18 or oxygen diffuser 20. With respect to thermal regulator material being on oxygen diffuser 20, it is contemplated that as the substrate 12 releases heat, oxygen diffuser 20 will deform and modify the oxygen access associated with oxygen diffuser 20. Thus, a heater could have a permanent deformation based upon the appropriately selected thermal regulator material that will permanently cut off oxygen access. Conversely, it is contemplated that the deformation be reversible.

If thermal regulator material is disposed on an adjacent structure, such as pad 18, oxygen diffuser 20, or in sheet 22, it has been found that increasing/maximizing the facial surface area contact between substrate 12 and structure with thermal regulator material will lead to better heat transfer into the thermal regulator and a slower reaction.

As previously discussed, such a heater, with thermal regulator material, is believed to provide many benefits, including the ability to control and select the maximum temperature of the heater.

### EXPERIMENT

A sheet of absorbent material (Blusorb®) was dipped into a container with melted paraffin wax (at approximately 70° C.). The sheet was allowed to completely soak in the melted wax. The sheet was then removed and allowed to cool by hanging it in the air.

After the sheet had cooled to room temperature, four separate test samples were cut out with a circular shape (1 in²). Each sample included between 0.18 to 0.20 g of wax.

The test samples were placed in a metal puck (with temperature probe/thermometer) and evenly coated with an electrolyte (saturated KCl). A similarly sized and shaped piece of heater substrate (including metal and binders) with a mass of 1.4 g was placed on top of the absorbent material. In order to ensure a sufficient interaction of the two, a small amount of pressure was applied to the heater substrate. An oxygen diffuser (buffalo felt) was placed on top of the heater substrate, and an air access layer placed on top of the air diffuser.

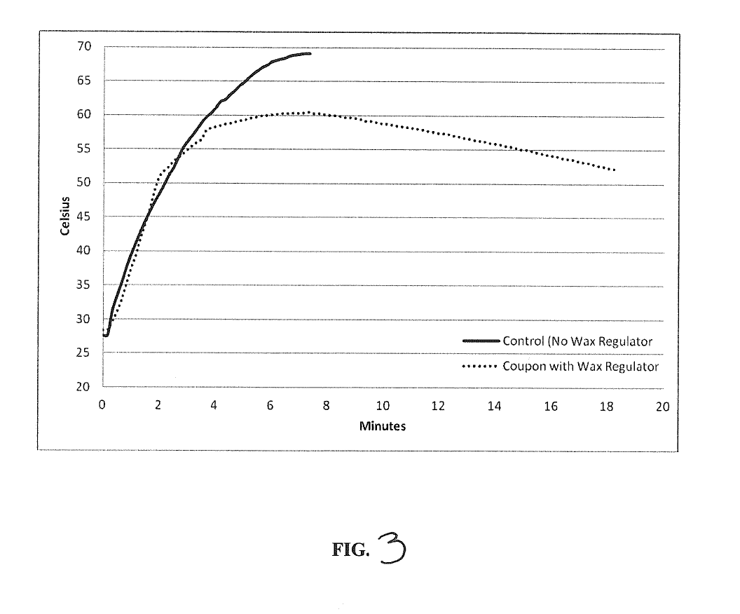

A first test sample was allowed to react with atmospheric oxygen in a metal puck. The test sample produced heat and various data points associated with same were recorded. The results were compared with temperature results for an identically sized heater control sample (without having any thermal regulator material). The comparison is shown in FIG. 3.

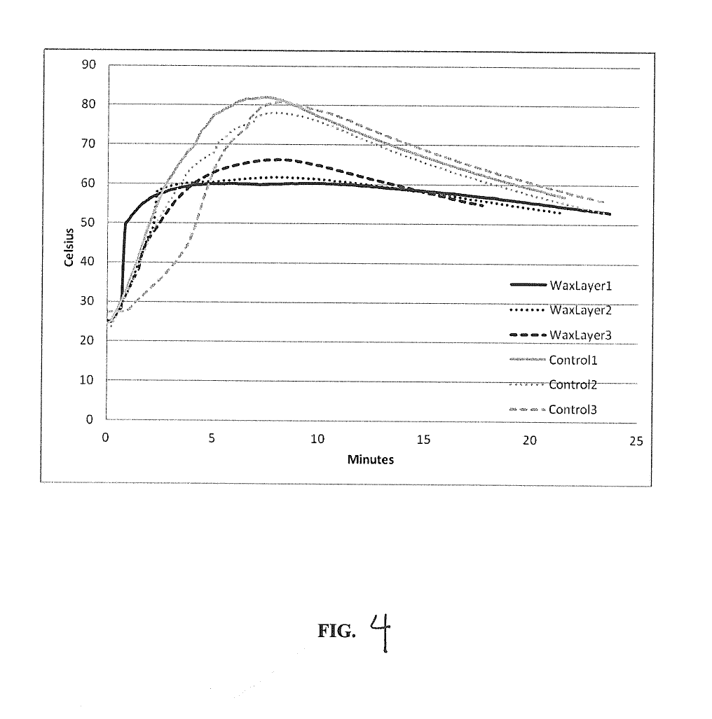

The three additional test samples were subsequently allowed to react with oxygen in a metal puck and the temperature was monitored, These results were compared with the temperature data for three more identically sized control heaters without wax. The comparison is shown in FIG. 4.

As can be seen in FIGS. 3 and 4, the thermal regulator material limited the temperature to approximately 60° C. (the melting temperature of the paraffin wax).

Furthermore, the presence of the thermal regulator material did not adversely affect the temperature rise. Indeed, all of the samples and all of the controls reached 60° C. in approximately 3 minutes. For the test, the particle sizes of the materials used to make both the test and control heaters were small—resulting in heaters that would rapidly begin producing heat.

It is believed that the results of one of the test samples indicate that the amount of wax used may be too little for a heater with a weight of 1.4 g. Thus, other weights and amounts are contemplated.

Based upon the percentage thermal regulator material total heat capacity (including heat of fusion) to total heat transfer from the heater sheet, the above experiments provided a 6% result, Thermal contact influences how much thermal regulator material is needed as heat will be lost to the environment. Since the determination of the amount of thermal regulator material, as well as the desired temperature, it is contemplated that between 5-60% thermal regulator material total heat capacity (including heat of fusion) to total heat transfer from the heater sheet would be most useful, Again, one of ordinary skill in the art will appreciate that other variables can influence the heater and thus, the present invention should not be limited to the disclosed values.

Nevertheless, the results indicated that thermal regulator material can be used to control the maximum temperature based upon the melting point of same, without negatively affecting the ability to quickly reach the target temperature and without negatively affecting oxygen access to the heater.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A heater comprising:
a substrate that produces heat in the presence of oxygen; and,
a thermal regulation material.

2. The heater of claim 1 wherein the substrate and thermal regulation material are disposed in a package and wherein the package includes a re-closable seal.

3. The heater of claim 2 wherein the heater has a maximum temperature of approximately 60° C.

4. The heater of claim 1 wherein the heater has a maximum temperature of approximately 60° C.

5. The heater of claim 1 wherein the thermal regulation material comprises a wax.

6. The heater of claim 1 wherein the thermal regulation material comprises a polymer.

7. The heater of claim 1 wherein the thermal regulation material is integral with the substrate.

8. The heater of claim 1 wherein the thermal regulation material comprises a sheet adjacent to and in thermal contact with the substrate.

9. The heater of claim 1 wherein the heater further comprises an electrolyte pad, and wherein the thermal regulation material is disposed on the electrolyte pad.

10. A heater comprising:
a substrate that produces heat in the presence of oxygen at a maximum temperature;
a package surrounding and enclosing substrate, the package including a seal for allowing selective oxygen access into package; and,
a thermal regulator material disposed inside of the package and having a melting point lower than the maximum temperature; and,
wherein the heater has a maximum temperature that is approximately the same as the melting point of the thermal regulation layer.

11. The heater of claim 10 wherein the thermal regulation material is integral with the substrate.

12. The heater of claim 10 wherein the thermal regulation material comprises a sheet adjacent to and in thermal contact with the substrate.

13. The heater of claim 10 wherein the heater further comprises an electrolyte pad disposed within the package and adjacent the substrate, and wherein the thermal regulation material is disposed on the electrolyte pad.

14. The heater of claim 10 wherein the thermal regulator material comprises a wax.

15. The heater of claim 10 wherein the heater has a maximum temperature of approximately 60° C.

16. A heater comprising:
a substrate including a binding agent and a reducing agent that produces heat in the presence of oxygen;
an electrolyte solution having a boiling point; and,
a thermal regulator material having a melting point that is lower than the boiling point of the electrolyte solution.

17. The heater of claim 16 further comprising:
a package surrounding the substrate, the electrolyte solution, and the thermal regulator, the package including a seal covering an opening;
an oxygen diffuser disposed between the opening and the substrate, wherein
the thermal regulator material is associated with the oxygen diffuser.
